(19) United States
(12) Patent Application Publication
(10) Pub. No.: US 2009/0279003 A1
(43) Pub. Date: Nov. 12, 2009

(54) LIQUID-CRYSTAL PROJECTION SYSTEM

(75) Inventors: Lujie QU, Shenzhen (CN); Rengui WANG, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: BUTTERFLY TECHNOLOGY (SHENZHEN) LIMITED, Shenzhen (CN)

(21) Appl. No.: 12/351,104

(22) Filed: Jan. 9, 2009

(30) Foreign Application Priority Data
May 6, 2008 (CN) 200810067085.X

(51) Int. Cl. G02F 1/13357

(52) U.S. Cl. 349/9

(57) ABSTRACT

A liquid-crystal projection system includes a light source emitting unpolarized light, a polarizing beam splitter, a single liquid crystal panel receiving polarized light P from said polarizing be m splitter, a projection lens, and a pre-polarizer placed between said light source and said polarizing beam splitter for polarizing said unpolarized light. The pre-polarizer includes a plurality of prisms combined together in succession, in which a plurality of inclined planes formed and connected continuously with each other, and a polarizing beam splitting film attached to said inclined plane configuring a polarizing beam splitting surface.

### CROSS-REFERENCE TO RELATED APPLICATIONS

This non-provisional application claims priority under 35 U.S.C. §119(a) on Patent Application No. 200810067085.X filed in China on May 6, 2008, the entire contents of which are hereby incorporated by reference.

### BACKGROUND OF THE INVENTION

1. Field of the Invention

The invention is related to projection systems, in particular to a liquid-crystal projection system with a pre-polarizer.

2. Background

As shown in FIGS. 1 and 2, traditional single-chip reflex liquid-crystal projection system comprises a light source 1, a polarizing beam splitter (PBS) 2, a reflex liquid-crystal chip 3, and a projection lens 4. The light source 1 may be a certain light source, and in itself includes a light filter for removing the ultraviolet and infrared light, a focusing lens group or an optical rod and so on. The light source 1 emits unpolarized light, which is divided into polarized light P and polarized light S vertical to each other after it enters the polarizing beam splitter 2. Generally, the polarizing beam splitter 2 looks like the shape of a cube, and constitutes two prisms with opposite angles painted with a polarizing beam splitting film which serves as the polarizing beam splitting surface. Referring to FIG. 1, the reflex liquid-crystal chip 3 lies where it can receive polarized light S emitted out of the polarizing beam splitter 2. Furthermore, it modulates polarized light S into polarized image light P which is then transmitted through the polarizing beam splitter 2 and enters the projection lens 4. In FIG. 2, the reflex liquid-crystal chip 3 lies where it can receive polarized light P emitted out of the polarizing beam splitter 2. Furthermore, it modulates polarized light P into polarized image light S which is then transmitted out and enters the polarizing beam splitter 2. Then polarized image light S is reflected by the polarizing beam splitting surface of the polarizing beam splitter 2 and enters the projection lens 4 finally.

Obviously, in FIG. 1, polarized image light P emitted from the polarizing beam splitter 2 will lose; while in FIG. 2 polarized light S emitted out of polarizing beam splitter 2 will lose. Furthermore, due to transmittance or reflectivity during transmission in the optical paths, polarized image light P or S will be subject to further loss of light. Therefore, in terms of existing technology, the single-chip liquid-crystal projection system has a low optical efficiency.

### SUMMARY OF THE INVENTION

It is an objective of the present invention to provide a liquid-crystal projection system with a pre-polarizer for transforming unpolarized light from light source into polarized light.

A liquid-crystal projection system in accordance with one embodiment of the present invention includes a light source emitting unpolarized light, a polarizing beam splitter, a single liquid crystal panel receiving polarized light P from said polarizing beam splitter, a projection lens, and a pre-polarizer placed between said light source and said polarizing beam splitter for polarizing said unpolarized light including a plurality of prisms combined together in succession, in which a plurality of inclined planes formed and connected continuously with each other, and a polarizing beam splitting film attached to said inclined plane configuring a polarizing beam splitting surface.

In some embodiments, said pre-polarizer is attached to a side wall of said polarizing beam splitter.

In some embodiments, at least two inclined planes are formed and said inclined planes configured to a corrugated shape.

In some embodiments, said pre-polarizer includes at least two prisms, said prisms are quadrate prisms, and polarizing beam splitting films attached to the surface of opposite angles of said prisms to configure said polarizing beam splitting surface respectively.

In some embodiments, said pre-polarizer includes at least three prisms with triangular cross section, wherein each two adjacent prisms constitutes said inclined plane which is also a connection surface, and said polarizing beam splitting film attached to the connection surface to configure said polarizing beam splitting surface respectively.

In some embodiments, inclination angle of said inclined plane is of 45°.

In some embodiments, cross section of said plurality of prisms combined together in succession as a whole is rectangle.

In some embodiments, said a plurality of prisms is glued together.

In some embodiments, a quarter-wave plate is attached to an optical incident face of partial prisms in the pre-polarizer.

The present invention can bring the following advantages:

The pre-polarizer in accordance with the above-mentioned embodiments is used to transform the unpolarized light from light source into polarized light. The pre-polarizer only emits polarized light P. Furthermore, part of polarized light S separated by the pre-polarizer will return back to the light source along the former path while another small part of polarized light S will be given off on the sides of the pre-polarizer. Then, due to its high purity and high transmittance in the polarizing beam splitter, polarized light P is provided for the polarizing beam splitter. This invention is to provide a liquid-crystal projection system which can make full use of polarized light P as illumination light and improve the optical efficiency at the same time.

Above all, by turning the polarizing beam splitter by 90°, the polarizing beam splitting surface within the polarizing beam splitter will be located at the position where the polarized light P from the pre-polarizer is transformed into polarized light S which is then emitted. The polarizing beam splitter is nearly able to transform all polarized light P into polarized light S which is then emitted. Then, the liquid-crystal panel receives polarized light S and modulates it into polarized image light P for emission. After emitted by the polarizing beam splitter, polarized image light P enters the projection lens. Polarized image light P has a high transmittance in the polarizing beam splitter. This invention greatly increases the amount of imaging light in the bright field but reduces the amount of light in the dark field, namely that this invention obviously improves the image contrast.

Furthermore, a quarter-wave plate can be placed on the partial optical incident faces of pre-polarizer. When polarized light S reflected out of the pre-polarizer returns back to the light source along the former path, it may be reflected into the pre-polarizer by the diffuse reflection plate of light source, then, it becomes polarized light P and is emitted out of the pre-polarizer after passing by the quarter-wave plate. In this way, the utilization ratio of light can be improved further.

### BRIEF DESCRIPTION OF THE DRAWINGS

FIG. 1 is a diagrammatic figure for an example of single-chip liquid-crystal projection system in terms of existing technology;

FIG. 2 is a diagrammatic figure for another example of single-chip liquid-crystal projection system in terms of existing technology;

FIG. 3 is a structural figure for a pre-polarizer comprising a plurality of quadrate prisms in accordance with one embodiment of the invention;

FIG. 4 is a structural figure for a pre-polarizer comprising a plurality of quadrate prisms in accordance with another embodiment of the invention;

FIG. 5 is a structural figure for a pre-polarizer comprising a plurality of quadrate prisms in accordance with another embodiment of the invention;

FIG. 6 is a structural figure for a pre-polarizer comprising a plurality of triangular prisms in accordance with another embodiment of the invention;

FIG. 7 is a structural figure for a pre-polarizer comprising a plurality of triangular prisms in accordance with another embodiment of the invention;

FIG. 8 is a structural figure for a pre-polarizer comprising a plurality of triangular prisms in accordance with another embodiment of the invention;

FIG. 9 is a structural figure for a pre-polarizer comprising a plurality of triangular prisms in accordance with another embodiment of the invention;

FIG. 10 is a structural figure for a pre-polarizer comprising a plurality of triangular prisms in accordance with another embodiment of the invention;

FIG. 11 is a structural figure for a pre-polarizer comprising a plurality of prisms in accordance with another embodiment of the invention, in which a quarter-wave plate is placed on an optical incident face of partial prisms;

FIG. 12 is a structural figure for a pre-polarizer comprising a plurality of prisms in accordance with another embodiment of the invention, in which a quarter-wave plate is placed on an optical incident face of partial prisms;

FIG. 13 is a structural figure for a pre-polarizer comprising a plurality of prisms in accordance with another embodiment of the invention, in which a quarter-wave plate is placed on an optical incident face of partial prisms;

FIG. 14 is a diagrammatic figure for a liquid-crystal projection system with a pre-polarizer in accordance with one embodiment of the invention;

FIG. 15 is a structural figure for a pre-polarizer glued together with a polarizing beam splitter in accordance with one embodiment of the invention;

FIG. 16 is a diagrammatic figure for a high-contrast liquid-crystal projection system in accordance with one embodiment of the invention;

FIG. 17 is a diagrammatic figure for a high-contrast liquid-crystal projection system in accordance with another embodiment of the invention; and

FIG. 18 is a diagrammatic figure for the pre-polarizer glued together with polarizing beam splitter as shown in FIG. 16.

### DETAILED DESCRIPTION OF THE INVENTION

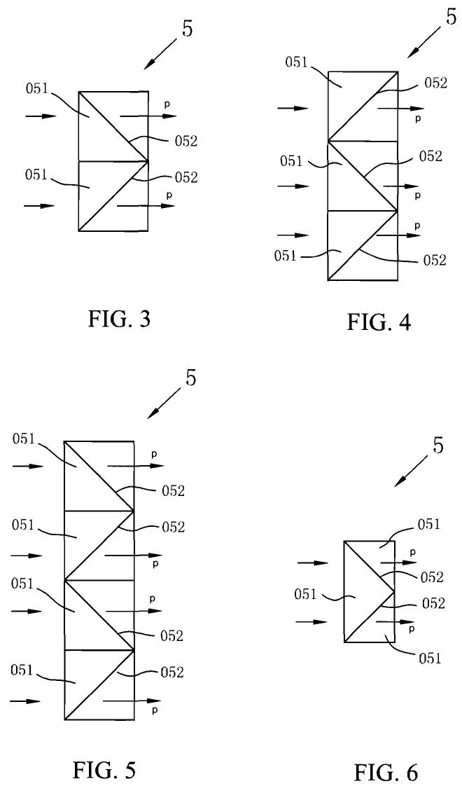

First of all, a detailed description is given to a pre-polarizer in accordance with some embodiments of the present invention as shown in FIGS. 3, 4, 5 and 6. The pre-polarizer 5 comprises a plurality of prisms 051 combined together in succession. The pre-polarizer 5 comprises a plurality of inclined planes 052 connected continuously with each other therein, namely that these inclined planes 052 are connected in order like a corrugated shape. A polarizing beam splitting film is attached at the inclined planes 052, which serves as the polarizing beam splitting surface. The number of the above-mentioned prisms 051 is two at least (see FIG. 3) while the number of the inclined planes 052 is two at least too (see FIGS. 3 and 6). When the number of the inclined planes 052 exceeds three, these inclined planes as a whole take on an indented form. On all of inclined planes 052, there is a polarizing beam splitting film which serves as the polarizing beam splitting surface. The methods used for making this polarizing beam splitting surface are the same as those for polarizing beam splitter (PBS), namely that the connection surface between two semi-prisms combined with each other is coated with a polarizing beam splitting film.

All of the prisms 051 may be quadrate prisms. On the surface of opposite angles of the prisms 051, there is a polarizing beam splitting film which serves as the polarizing beam splitting surface. The surface of opposite angles is also the above-mentioned inclined plane 052. FIG. 3 is an illustration for this pre-polarizer 5 composed of quadrate prisms 051. In this embodiment, the pre-polarizer 5 comprises two quadrate prisms 051 of which two inclined planes 052 of opposite angles are polarizing beam splitting surface. Furthermore, the two inclined planes 052 of opposite angles are connected with each other.

As shown in FIG. 4, the pre-polarizer 5 comprises three quadrate prisms 051 which are continuously connected with each other, including three inclined planes 052 which are all the polarizing beam splitting surface. In FIG. 5, the pre-polarizer 5 comprises four quadrate prisms 051 which are connected with each other in order, including four inclined planes 052 on which there is a polarizing beam splitting film which serves as the polarizing beam splitting surface. The number of the above-mentioned quadrate prisms 051 shall be two at least. The pre-polarizer 5 can be composed of more quadrate prisms 05 1. The more the number is, the better the uniformity of polarized light P emitted out of pre-polarizer 5 will be, but the cost of the pre-polarizer 5 will increase accordingly.

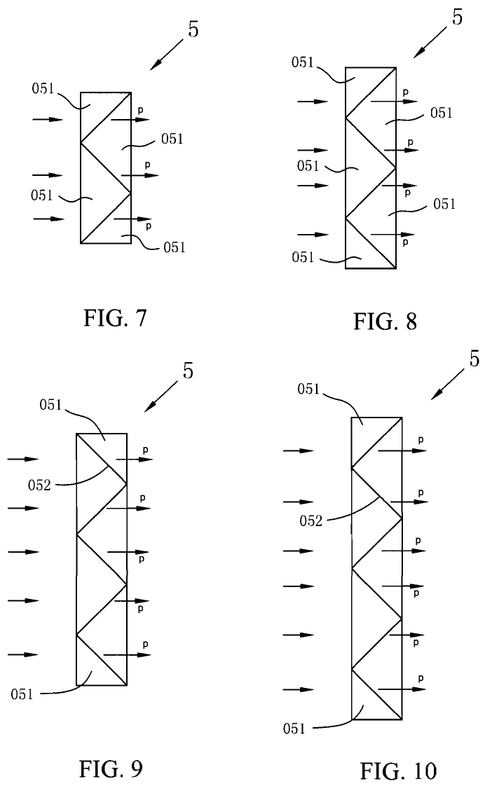

All of the prisms 051 may be the prisms with triangular cross section, as shown in FIGS. 6, 7, 8, 9 and 10. The number of prisms 051 shall be three at least, with each two adjacent prisms 051 constituting an inclined plane which is also the connection surface. On the connection surface there is a polarizing beam splitting film which serves as the polarizing beam splitting surface. In FIG. 6, the pre-polarizer 5 comprises three prisms 051 which are continuously connected with each other, including two inclined planes 052. In FIG. 7, the pre-polarizer 5 comprises four prisms 051 which are continuously connected with each other, including three inclined planes which are all the polarizing beam splitting surface.

Referring to FIG. 8, the pre-polarizer 5 comprises five triangular prisms 051 which are connected with each other in order, including four corrugated inclined planes. In FIG. 9, the pre-polarizer 5 comprises six triangular prisms 051 which are connected with each other in order, including five corrugated inclined planes 052 which are all the polarizing beam splitting surface. In FIG. 10, the pre-polarizer 5 comprises seven triangular prisms 051 which are continuously connected with each other, including six indented inclined planes 052 which are all the polarizing beam splitting surface. The prisms 051 which the pre-polarizer 5 comprises are in the form of array. There is no limit on the number of prisms 051. The more the number is, the better the uniformity of polarized light P emitted out of the pre-polarizer 5 will be, but the cost of the pre-polarizer 5 will increase accordingly.

It is preferred that the inclination angle of the above-mentioned inclined planes 052 is of 45° so that the beam of light from light source can shine down on the polarizing beam splitting surface to achieve the best effect of polarizing beam splitting and have the polarized light P emitted out of the pre-polarizer 5 vertically.

If the pre-polarizer 5 is all composed of the quadrate prisms 051 which are connected with each other in order, the cross section of pre-polarizer 5 as a whole is like a rectangle, namely that the whole pre-polarizer 5 is like a quadrate plate. Due to its structure with these characteristics, the pre-polarizer 5 can be easily assembled in the optical system.

If the pre-polarizer 5 is all composed of the prisms 051 with a triangular cross section which are connected with each other in order, the whole cross section of the pre-polarizer 5 can be designed as a rectangle, namely that the whole pre-polarizer 5 looks like a quadrate plate. As shown in FIGS. 6, 7, 8, 9 and 10, on both sides of the pre-polarizer 5, two prisms 051 are both right-angled triangular prisms. By means of compensation design, the edge angle of the pre-polarizer 5 is a right angle, so that the whole cross section of several prisms 051 continuously connected with each other looks like a rectangle, namely that the whole cross section of the pre-polarizer 5 is like a rectangle. The pre-polarizer 5 looks like a quadrate plate, with a small volume, so it can be easily assembled in the optical system.

Of course, the pre-polarizer 5 can be made of both quadrate and triangular prisms too, because the cross section of the pre-polarizer 5 composed of triangular prisms can be designed as a rectangle, which can be thus connected with several quadrate prisms.

The prisms 051 are compactly glued together with each other so the pre-polarizer 5 possesses a reliable structure.

The pre-polarizer 5 is used to polarize the unpolarized light from light source. Whether the beam of light enters the front or back of the pre-polarizer 5, the polarizing beam splitting surface within the pre-polarizer 5 will transform the unpolarized light into polarized light and have it emitted out. For details please see the optical paths illustrated by arrows in the attached figures.

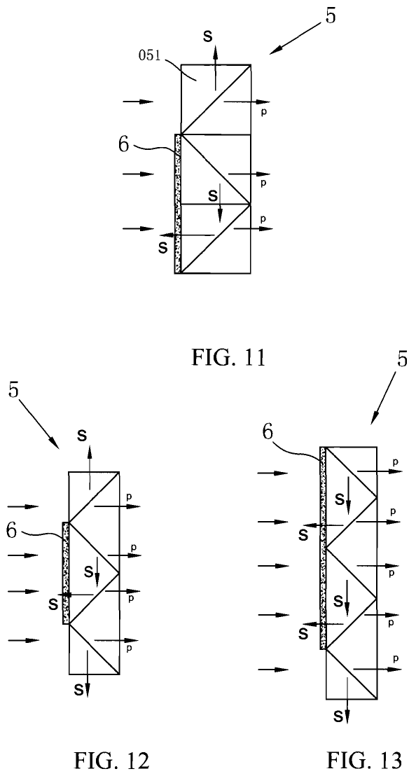

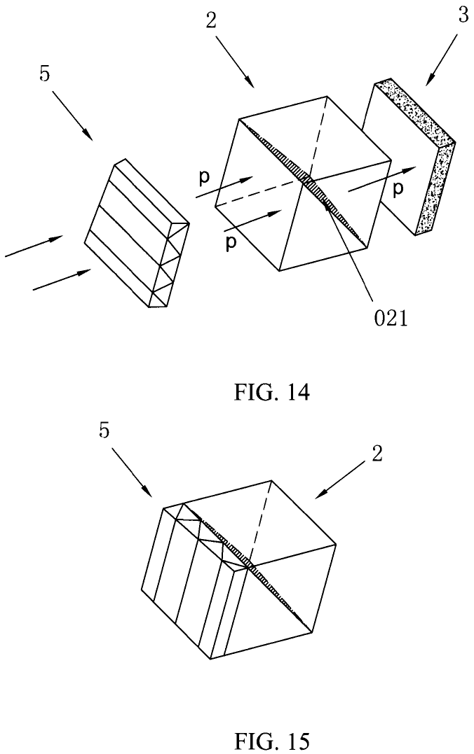

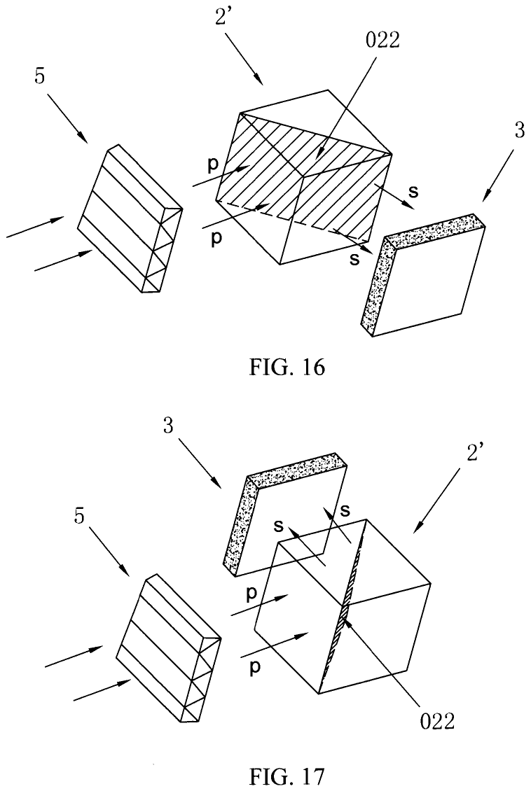

The pre-polarizer 5 emits polarized light P vertically. Part of polarized light S separated by pre-polarizer 5 will return back to the light source along the former path while another part of polarized light S will be given off on the sides of the pre-polarizer 5 (For details please see FIGS. 11, 12 and 13). Therefore, the purity of polarized light P emitted out of the pre-polarizer is very high.

The pre-polarizer 5 can be as improved as shown in FIGS. 11, 12 and 13. A quarter-wave plate 6 is placed on the optical incident face of partial prisms 051 in the pre-polarizer 5. A better way is that the quarter-wave plate 6 is glued on the end face of the prisms 051. The pre-polarizer 5 has multiple kinds of structure, so there are many other methods to place the quarter-wave plate 6.

The reason for use of the quarter-wave plate 6 is that: when polarized light S reflected out of the pre-polarizer 5 returns back to the light source along the former path, it may be reflected into the pre-polarizer 5 by the diffuse reflection plate of light source, then, it becomes polarized light P and is emitted out of the pre-polarizer after passing by the quarter-wave plate 6. In this way, the utilization ratio of light can be improved further.

As shown in FIG. 14, the liquid-crystal projection system equipped with the above-mentioned pre-polarizer 5 is provided for this invention, comprising a light source (not shown in the figure), a polarizing beam splitter 2, a single liquid crystal panel 3 and a projection lens (not shown in the figure) which constitute a projecting light path. The above-mentioned single liquid crystal panel 3 is used to receive polarized light P from the polarizing beam splitter 2. The pre-polarizer 5 is placed between the light source and the polarizing beam splitter 2. FIG. 14 is a three-dimensional structural figure in which the liquid-crystal projection system is similar to the single-chip liquid-crystal projection system as shown in FIG. 2 in Background Technology, but their difference is that in FIG. 14 the pre-polarizer 5 is added between the light source and the polarizing beam splitter 2. Therefore, the optical paths in FIG. 14 may be by reference to those in FIG. 2. First of all, the light source emits unpolarized light which is transformed into polarized light P after passing through the pre-polarizer 5. Then, polarized light P enters the polarizing beam splitter 2, and is reflected by the polarizing beam splitting surface 021, and then illuminates the single liquid crystal panel 3. Due to high transmittance of polarized light P, the liquid-crystal projection system is able to make the best use of polarized light P from illumination light.

It is preferred that, as shown in FIG. 15, the pre-polarizer 5 should be glued on the end face of the polarizing beam splitter 2 and thus combined with the polarizing beam splitter 2. In this way, a reliable structure can be realized, and the volume of liquid-crystal projection system can be reduced.

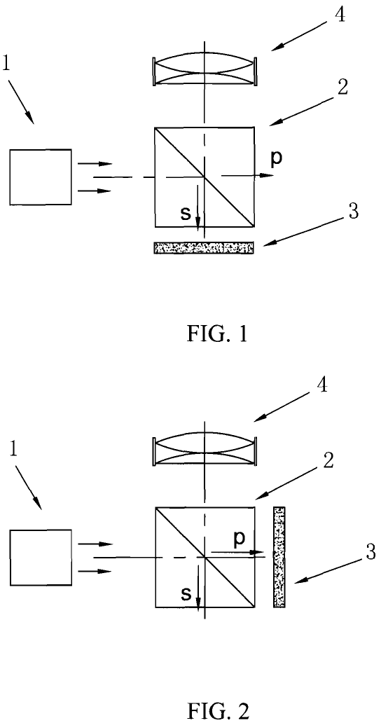

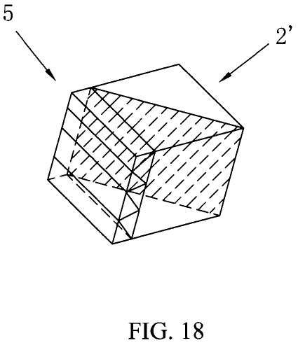

As shown in FIG. 16, this invention mainly aims at providing a high-contract liquid-crystal projection system, which comprises a light source (not shown in the figure), a polarizing beam splitter 2′, a single liquid crystal panel 3, and a projection lens (not shown in the figure). Furthermore, the pre-polarizer 5 mentioned above is placed on the optical path between the light source and the polarizing beam splitter 2′. The structural position of the polarizing beam splitter 2′ is different from that of the polarizing beam splitter 2 as shown in FIGS. 1, 2 and 14. A polarizing beam splitting surface 022 within the polarizing beam splitter 2′ is located at the position where polarized light P from the pre-polarizer 5 is transformed into polarized light S. This is realized by turning the polarizing beam splitter 2 in FIG. 14 by 90°. By turning the polarizing beam splitter 2 in FIG. 14 by 90°, namely turning the polarizing beam splitting surface 021 by 90°, the polarizing beam splitter 2′ and the polarizing beam splitting surface 022 as shown in FIG. 16 can be thus achieved. Due to the fact that polarized light P is vertical to polarized light S, polarized light P in FIG. 14 is emitted through the polarizing beam splitting surface 021. In FIG. 16 the polarizing beam splitting surface 022 is vertical to the polarizing beam splitting surface 02 1, so after passing through the polarizing beam splitting surface 022, polarized light P is transformed into polarized light S and reflected out.

The above-mentioned single liquid crystal panel 3 receives the above polarized light S and modulates it into polarized image light P which is then emitted, and transmitted through the polarizing beam splitter 2′, and provided for the projection lens finally.

The pre-polarizer 5 transforms the unpolarized light from the light source into polarized light P which is used to illuminate the above liquid crystal panel 3. Due to the fact that the purity of polarized light P is very high and the polarizing beam splitter 2′ can basically transform polarized light P from pre-polarizer 5 into polarized light S which is then provided for the single liquid crystal panel 3, so the purity of polarized light P is also very high accordingly. Polarized image light P generated by the single liquid crystal panel 3 is transmitted through the polarizing beam splitter 2′, and in addition, the polarized image light P has a high transmittance in the polarizing beam splitter 2′, so when the liquid-crystal projection system displays images, it can greatly increases the amount of P light in the bright field, and reduce the amount of P light and S light in the dark field. As a result, the liquid-crystal projection system is able to greatly improve the image contrast (which is the ratio of bright-field imaging light amount to the dark-field imaging light amount). The following are detailed descriptions: when the single liquid crystal panel 3 is illuminated, it is in the bright field and it provides the illumination light with image message. When the single liquid crystal panel 3 is off, it is in the dark field, and at this time, it serves as a reflecting mirror which reflects back a good deal of polarized light S and a little of polarized light P from the polarizing beam splitter 2′. Then polarized light S is reflected back to the former path by the polarizing beam splitting surface 022. Polarized light S has a high reflection rate but a low transmittance in the polarizing beam splitter 2′, namely that the polarized light S reflected by the single liquid crystal panel 3 cannot enter the projection lens, also namely that in the state of dark field, the amount of light entering the projection lens for imaging is very small.

As shown in FIG. 17, by turning the polarizing beam splitter 2 by 90° in another direction, both the polarizing beam splitter 2′ and the polarizing beam splitting surface 022 can be realized as shown in FIG. 17. The polarizing beam splitting surface 022 is also located at the position where the polarized light P from the pre-polarizer 5 is transformed into polarized light S which is then emitted, namely that FIG. 17 is another type of high-contrast single-chip liquid-crystal projection system as described by this invention.

In addition, as for this invention, the light source for liquid-crystal projection system is a metal lamp or a LED light source or a laser light source, and the liquid-crystal panel is a LCOS (Liquid Crystal on Silicon).

FIG. 18 shows the best ways of placing the pre-polarizer 5 between the light source and the polarizing beam splitter 2′. The pre-polarizer 5 is often glued on the end face of the polarizing beam splitter 2′ and thus combined with the polarizing beam splitter 2′. In this way, a reliable structure can be achieved, and the volume of liquid-crystal projection system can be reduced.

What is claimed is:

1. A liquid-crystal projection system, comprising:
a light source emitting unpolarized light,
a polarizing beam splitter,
a single liquid crystal panel receiving polarized light P from said polarizing beam splitter,
a projection lens, and
a pre-polarizer placed between said light source and said polarizing beam splitter for polarizing said unpolarized light comprising a plurality of prisms combined together in succession, in which a plurality of inclined planes formed and connected continuously with each other, and a polarizing beam splitting film attached to said inclined plane configuring a polarizing beam splitting surface.

2. The liquid-crystal projection system as claimed in claim 1, wherein said pre-polarizer is attached to a side wall of said polarizing beam splitter.

3. The liquid-crystal projection system as claimed in claim 1, wherein at least two inclined planes are formed and said inclined planes configured to a corrugated shape.

4. The liquid-crystal projection system as claimed in claim 1, wherein said pre-polarizer comprises at least two prisms, said prisms are quadrate prisms, and polarizing beam splitting films attached to the surface of opposite angles of said prisms to configure said polarizing beam splitting surface respectively.

5. The liquid-crystal projection system as claimed in claim 1, wherein said pre-polarizer comprises at least three prisms with triangular cross section, wherein each two adjacent prisms constitutes said inclined plane which is also a connection surface, and said polarizing beam splitting film attached to the connection surface to configure said polarizing beam splitting surface respectively.

6. The liquid-crystal projection system as claimed in claim 1, wherein inclination angle of said inclined plane is of 45°.

7. The liquid-crystal projection system as claimed in claim 1, wherein cross section of said plurality of prisms combined together in succession as a whole is rectangle.

8. The liquid-crystal projection system as claimed in claim 1, wherein said plurality of prisms is glued together.

9. The liquid-crystal projection system as claimed in claim 1, wherein a quarter-wave plate is attached to an optical incident face of partial prisms in the pre-polarizer.

10. A liquid-crystal projection system, comprising:
a light source,
a polarizing beam splitter,
a single liquid crystal panel.
a projection lens, and
a pre-polarizer placed between said light source and said polarizing beam splitter comprising a plurality of prisms combined together in succession,
wherein a polarizing beam splitting surface within the polarizing beam splitter lies at the position where polarized light P from said pre-polarizer is transformed into polarized light S; and said single liquid crystal panel receives said polarized light S and modulates it into polarized image light P which is then emitted and transmitted through said polarizing beam splitter, and provided for the projection lens.

11. The liquid-crystal projection system as claimed in claim 10, wherein said pre-polarizer is attached to a side wall of said polarizing beam splitter.

12. The liquid-crystal projection system as claimed in claim 10, wherein said light source is a meta lamp, or a LED light source, or a laser light source

13. The liquid-crystal projection system as claimed in claim 10, wherein the single liquid-crystal panel is a LCOS.

14. The liquid-crystal projection system as claimed in claim 10, wherein a plurality of prisms forms at least two inclined planes and said inclined planes configured to a corrugated shape.

15. The liquid-crystal projection system as claimed in claim 10, wherein said pre-polarizer comprises at least two prisms, said prisms are quadrate prisms, and polarizing beam splitting films attached to the surface of opposite angles of said prisms to configure said polarizing beam splitting surface respectively.

16. The liquid-crystal projection system as claimed in claim 10, wherein said pre-polarizer comprises at least three prisms with triangular cross section, wherein each two adjacent prisms constitutes said inclined plane which is also a connection surface, and said polarizing beam splitting film attached to the connection surface to configure said polarizing beam splitting surface respectively.

17. The liquid-crystal projection system as claimed in claim 10, wherein inclination angle of said inclined plane is of 45°.

18. The liquid-crystal projection system as claimed in claim 10, wherein cross section of said plurality of prisms combined together in succession as a whole is rectangle.

19. The liquid-crystal projection system as claimed in claim 10, wherein said plurality of prisms is glued together.

20. The liquid-crystal projection system as claimed in claim 10, wherein a quarter-wave plate is attached to an optical incident face of partial prisms in the pre-polarizer.
